(19) United States
(12) Patent Application Publication
(10) Pub. No.: US 2015/0227985 A1
(43) Pub. Date: Aug. 13, 2015

(54) METHOD AND ELECTRONIC SYSTEM FOR EMITTING A DIGITAL ADVERTISEMENT

(71) Applicant: RTB HOUSE S.A., Warszawa (PL)

(72) Inventor: Robert Dyczkowski, Warszawa (PL)

(21) Appl. No.: 14/432,454

(22) PCT Filed: Apr. 17, 2014
(86) PCT No.: PCT/IB2014/060819

§ 371 Date: Mar. 30, 2015

(30) Foreign Application Priority Data
Jul. 26, 2013 (PL) P.404876

(51) Int. Cl. G06Q 30/02

(52) U.S. Cl. CPC G06Q 30/0277

(57) ABSTRACT

Systems may perform operations and methods may include steps including receiving information requesting display of the joint digital advertisement for a product or service; automatically selecting one of a plurality of combinations of entities to be promoted on the joint digital advertisement, wherein the entities are related to the joint digital advertisement in that each entity participates in a supply chain for the product or service being advertised; preparing a graphical representation of the joint digital advertisement for display, using a template of an advertising banner, which is filled with data including information about at least one offer from a set of offers common to the one of the plurality of combinations of entities; and providing feedback to display the joint digital advertisement to a user.

The object of the invention is a method and an electronic system for emitting a joint digital advertisement of several entities, which is co-financed by these entities and implemented automatically. In particular, the focus is on a method of automatic selection of entities, which are to finance the advertisement, of pricing and of preparation of digital advertisements concerning several entities belonging to a single supply chain of products or services.

Most of the products or services offered on the market are delivered to the end customer not directly from the manufacturer, but through various entities within a supply chain. Examples include typical consumer goods, which are produced by manufacturers, later potentially distributed by agents, and eventually sold in stores offering products of many manufacturers.

Considering the fact that any entity in a supply chain wants the product or service to be eventually sold to the end consumer, these entities are willing to spend some financial resources on marketing targeted at the end recipient. It is not only about the entities at the end of the chain (i.e. those from which the end consumer eventually purchases the product or service), but also the earlier ones, e.g. manufacturers or wholesale distributors. Because of the willingness to make more efficient use of their advertising budgets, the entities in the supply chain often co-finance advertising campaigns. A simple example may be traditional advertising billboards. A store offering products of many manufacturers, which wants to advertise, can buy an advertisement on its own, or it can buy an advertisement together with the manufacturer of a given product, in return for which, on the store's advertisement, a logo or a product of a given manufacturer will also be presented. Thus, both the store and the manufacturer benefit, and with reduced costs can achieve better results in the form of higher values of sales within the given supply chain (wherein each entity works in its own interest).

The following state-of-the-art solutions are currently available: U.S. Pat. No. 8,447,651 presenting a method of bidding during ongoing advertising campaigns, U.S. Pat. No. 8,131,594 relating to, among others, a method of providing an advertisement in response to a request of an advertiser and generating an advertising fee to be paid by the advertiser based on the purchase history of the user and WO201303287 which relates to a method of displaying digital advertisements and to a model of financial settlement with an advertiser which occurs in response to a selection of advertisement watched by the user.

Unfortunately, none of these solutions solve the problem of automatic selection of entities which want to jointly create, and therefore also co-finance, the advertisement.

Within the framework of the following document, emitting a joint advertisement co-financed by several entities should be understood not only as the context of a financial settlement. The object here is a more complex whole, which further consists of a presentation of a single consistent graphical display of an ad, which yields benefits to each of the entities. In the graphical view, respective logos, as well as offers targeted at the end consumer are most often presented. These offers are ultimately sold to the end consumer by only one of the entities, yet the sense of promoting these offers and financing such consistent advertising by other entities results from relations occurring within the supply chains.

Emission of a joint advertisement co-financed by several entities in the context of the present invention is to be distinguished from the situation in which several entities somehow jointly finance a single display of advertising space within which independent advertisements of each of the entities are to be presented. For example, on an advertising banner with dimensions of 400×400 pixels where normally an advertisement of a single entity is placed, advertisements of two entities of the size of 400×200 pixels each can be placed automatically, so that the cost of the display from the viewpoint of each of the entities is lower. However, these are, in fact, two independent advertisements, and each of them is related to a single entity. Each of the advertisements makes sense and can be displayed independently of the other; in this situation, co-financing applies only to the financial settlement for purchasing the advertising space. These automatic solutions are currently used in practice. The entities which jointly finance the advertising space can, in this situation, be completely independent of each other and here is no requirement for any relationship herein. This situation is different from the emission of a joint advertisement as defined in the present invention, where apart from financial matters, the emission consists of at least a coherent concept for the graphical display of an ad concerning several entities. This type of advertising makes sense when the entities are in some way related, when one of the entities can benefit even though it is the other entity which ultimately sells the offer to the end consumer. This situation may arise, in particular, in cases where the considered entities belong to a single supply chain. In this situation, the intermediate entities in the chain may want the end consumer to purchase the offer from the entity which occurs at the end of the chain, thereby several entities may be interested in financing a single joint advertisement.

From the business perspective, the invention is applicable in industries where there is a willingness to co-finance marketing campaigns by several entities. The use of the invention in the field of marketing in these industries can introduce a new quality, allowing the emission of joint advertisements to be realised automatically, wherein the whole process consists of steps such as: selection of entities willing to finance the advertisement and pricing and preparation of joint digital advertisements co-financed by several entities. The solutions currently used do not allow for automation of the whole process. Although there are automated solutions allowing to share purchasing costs of advertising space for the purposes of independent campaigns, these solutions do not allow for automation of the whole process of emission of a single joint advertisement of several entities. The mentioned process including both sharing of costs and presentation of a single consistent graphical view, yields benefits to each of the entities.

### TERMINOLOGY

The term Offer included in the description of the invention shall be understood as a consumer good in the form of a product or a service.

The term Supply chain of an offer included in the description of the invention shall be understood as a list of entities which participate in the process of delivering the offer to the end consumer. They can include manufacturers, agents and end entities which eventually sell the offer to the final consumer. An example supply chain of a product may be the following: Manufacturer, wholesaler, store. A single offer may be distributed to the end consumers through a number of supply chains, for example, a particular product can be offered by a number of independent stores.

The term B2C entity included in the description of the invention shall be understood as an entity offering/selling goods or services directly to the end consumer. An example can be an online store offering goods from a number of manufacturers, or a travel agency offering tours of various tour operators.

The term B2B entity included in the description of the invention shall be understood as an entity which sells products or services to other entities in the supply chain, but not directly to the end consumer. In other words, each entity in a supply chain of a particular product or service which is not a B2C entity is a B2B entity. A B2B entity can sell offers to both B2B and B2C entities. An example of such entity can be a manufacturer whose products are, along the supply chain, sold to the end customer not directly by it, but by the stores offering goods of a number of manufacturers. NOTE: The same entity may, within various supply chains, act sometimes as a B2C entity and sometimes as a B2B entity.

The term Set of offers common to a combination of entities included in the description of the invention, shall be understood as such a subset of offers, for which for each offer from the set, there is at least one supply chain, which contains all the entities belonging to the particular combination. For example, supply chains for four offers are presented below:

### Offer 1:

### Manufacturer 1, Wholesaler 1, Store 1

### Manufacturer 1, Wholesaler 1, Store 2

### Offer 2:

### Manufacturer 1, Wholesaler 2, Store 1

### Manufacturer 1, Wholesaler 2, Store 2

### Offer 3:

### Manufacturer 2, Wholesaler 1, Store 1

### Manufacturer 2, Wholesaler 1, Store 2

### Offer 4:

### Manufacturer 2, Wholesaler 2, Store 1

### Manufacturer 2, Wholesaler 2, Store 2

Sets of offers common to example combinations of entities are presented below:

| Combination of entities | Set of common offers |
|---|---|
| Manufacturer 1; Store 1 | Offer 1; Offer 2 |
| Wholesaler 1; Store 2 | Offer 1; Offer 3 |
| Manufacturer 2; Wholesaler 2; Store 1 | Offer 4 |
| . . . | . . . |

The term Operator of advertising space included in the description of the invention shall be understood as an entity whose task is to technically display the advertisement in an empty advertising placement and to appropriately settle the transaction between the provider of advertising space (its owner) and the entity whose advertisement has been displayed. An example of operators of advertising space may be advertising networks. The operator of advertising space can provide advertising space in a number of models. The simplest payment model, in the case where advertising space is made available exclusively to one entity/advertiser, may be a fixed rate for each display of the advertisement. The more complex model under which the space can be made available to a number of entities/advertisers can be the Real-Time Bidding model based on bidding for each advertising display independently.

The term Context data of an advertising display included in the description of the invention shall be understood as a set of information processed each time when there is a need for a single advertising display. If the advertising space is made available to external entities in the bidding model, the operator of advertising space sends each time the context data of the advertising display to the interested entities, so that they can return information whether they want to purchase a particular display. If willing to purchase, these entities return information to the operator about what advertisement they would like to display + the rate for its settlement. As a minimum option, the context data of display includes potential sizes of the advertising banner to be displayed (for example 728×90 pixels in the case of advertisement on a website). In addition, it can be extended by many elements such as the url address of the website on which the advertisement is to be displayed (in the case of online advertising), information about the user, geolocation data, etc. This additional information can be used by entities potentially interested in displaying the advertisement for the purpose of targeting advertisements at a specific target group or for a more detailed pricing of a given advertising display.

The term Graphical representation of an ad included in the description of the invention shall be understood as an electronic record of the view which is to be displayed to the user at whom the advertisement is targeted. This view may have the form of a graphics file, or of any other method of storing graphical information. This could be, for example, a bitmap, an html document, a flash file, a video file or even a combination of these. In particular, the graphical representation of an ad does not have to be static, but can be animated, also enriched with sound effects.

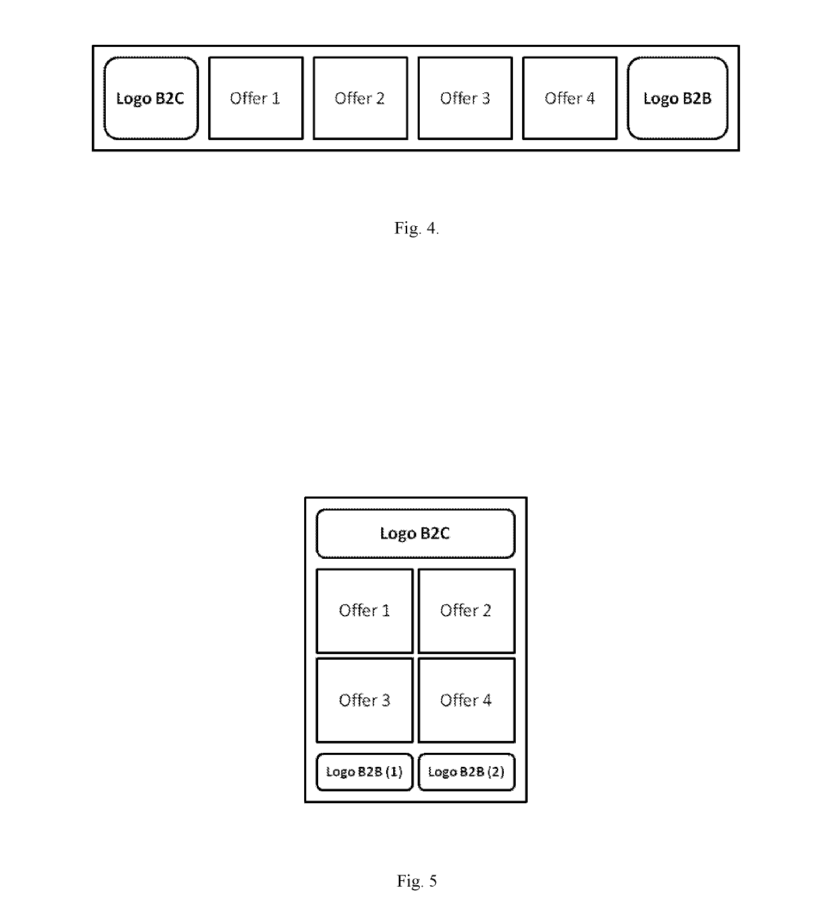

The term Template of an advertising banner included in the description of the invention shall be understood as a graphical template for advertisement with blank spaces being left; the spaces mentioned could be filled with logos of the entities financing the advertisement, a colour scheme, photographs or descriptions of their offers, animations, etc. After completing the template of the advertising banner with specific data, it takes the form of a graphical representation of an ad, which can be displayed to the end user. In the drawings of FIG. 4 and FIG. 5 sample templates of advertising banners are presented.

The term Payment model for an advertising campaign included in the description of the invention shall be understood as a way in which the advertising entity will be financially settled for the realisation of the advertising campaign, taking into account the specific rates. The most popular payment models may involve a specific rate for each display of the advertisement, or a rate paid for each click on the advertising banner. Entities willing to promote their offers can usually choose the payment model or have to accept a model imposed on them in advance (in the context of a particular advertising service). Based on payment models declared by entities willing to finance a particular display, a total value of a particular display can be calculated or estimated. This value can be used by the operator of advertising space for future financial settlement with the owner of the advertising space. Payment models for particular entities financing a single display, as well as the model of payment with the owner of advertising space, may vary.

The term Targeting of an advertising campaign included in the description of the invention shall be understood as a set of logical expressions narrowing the context of advertising displays which the particular entity wants to finance as part of an advertising campaign. An example of targeting of advertising campaign may be narrowing the context of displays only to a particular website. In this case, the entity will participate in co-financing of the online advertising only when the display occurs on the selected website. Another example of targeting may be a geotargeting which narrows of the context of advertising displays, for example, limiting it to the territory of Poland. In the case of the co-financed advertisements, targeting may also include entity's preferences concerning with which entities it wants to potentially co-finance the advertisements, and with which ones it does not.

Subject of the invention is a method of emitting a digital advertisement, comprising the following steps:
a) reception of information about the possibility to display an advertisement,
b) automatic selection of one of the combinations of entities which are related to the joint advertisement,
c) preparation of a graphical representation of an ad,
d) providing feedback necessary to display the advertisement to the user and for financial settlement.

Preferably, the reception of information about the possibility to display the advertisement comprises, in particular, electronic transmission of context data of the advertising display.

Preferably, the selection of one of the combinations of entities, which are related to the joint advertisement, is limited only to those combinations for which the set of common offers comprises at least one element.

Preferably, the selection of one of the combinations of entities which are related to the joint advertisement is made from the set of all potential combinations of entities.

Preferably, the one of the automatically selected combinations of entities, which are related to the joint advertisement, meets the targeting criteria of advertising campaigns of particular entities.

Preferably, in the method according to the invention, step b) consists of selecting, from the considered combinations, the one for which the calculated pricing of a display will be the highest.

Preferably, the selection, from the considered combinations, of the one for which the calculated pricing of display will be the highest, is made on the basis of the pricing based on payment models declared by the particular entities which are related to the given display of the joint advertisement.

Preferably, in the method according to the invention, step b) consists of selecting a combination of entities which comprises exactly one B2C entity and at least one B2B entity.

Preferably, step c) consists of automatic generation of the graphical representation of an ad at the current moment.

Preferably, in the method according to the invention, step c) consists of indicating an already existing graphical representation of an ad, generated before the beginning of the advertisement emission process.

Preferably, the generation of the graphical representation of an ad is realised on the basis of the template of an advertising banner which is filled with data, preferably logos of the entities financing the advertisement, information about offers from the subset of the set of offers common to the selected combination of entities.

Preferably, the generation of the graphical representation of an ad is realised on the basis of the template of an advertising banner of B2C entity belonging to the combination of entities which are related to the joint advertising display.

Preferably, the subset of the set of offers common to the combination of entities, which are related to the joint advertisement, is narrowed on the basis of the context data of the advertising display. (For example, the category of the site on which the advertisement is to be displayed may determine the category of offers which are to appear in the graphical representation of an ad.)

Preferably, in the method according to the invention, step d) consists, in particular, of providing the graphical representation of an ad, which is to be displayed to the end user.

Preferably, in the method according to the invention, step d) consists, in particular, of providing the pricing performed on the basis of payment models of particular entities which are related to the joint advertisement.

Preferably, in the method according to the invention, step d) consists, in particular, of providing a list of entities which are related to the joint advertisement, together with information about payment models of each entity.

The subject of the invention is also an electronic system for emitting a digital advertisement, comprising elements such as a database, a communication interface, and a database-integrated mechanism allowing the performance of the following functions:
a) reception of information about the possibility to display an advertisement,
b) automatic selection of one of the combinations of entities, which are related to the joint advertisement,
c) preparation of a graphical representation of an ad,
d) providing feedback necessary to display the advertisement to the user and for financial settlement.

Preferably, in the electronic system according to the invention, function a) is performed by means of electronic transmission of data related to the context data of the advertising display.

Preferably, in the electronic system according to the invention, function b) is performed with the use of a module which communicates with the database, the module, based on the information contained in the database, which selects from the set of all potential combinations of entities, such a combination of entities for which the targeting criteria are met, and simultaneously for which the set of common offers comprises at least one element.

Preferably, in the electronic system according to the invention, function b) is performed in such a way that the selection of the final combination of entities is made on the basis of the highest pricing of the joint advertising display.

Preferably, in the electronic system according to the invention, the function for pricing the joint advertising display for a given combination of entities is performed with the use of an appropriate module which communicates with the database.

Preferably, in the electronic system according to the invention, the function for pricing the joint advertising display for a given combination of entities, with the use of an appropriate module communicating with the database, is performed based on the information contained in this database, the information being related to financial settlements declared by particular entities, which are related to the given display of the joint advertisement.

Preferably, in the electronic system according to the invention, function b) is performed with the use of information from the database in such a way that the selected combination of entities comprises exactly one B2C entity and at least one B2B entity.

Preferably, in the electronic system according to the invention, function c) is performed through automatic generation of the graphical representation of an ad at the current moment.

Preferably, in the electronic system according to the invention, function c) is performed through indication, in the database, of the prepared graphical representation of an ad, generated before the beginning of the advertisement emission process.

Preferably, in the electronic system according to the invention, the generation of the graphical representation of an ad is performed by the module communicating with the database, which automatically fills the template of an advertising banner with graphical elements, preferably with logos of entities financing the advertisement, or with information related to the offers from the subset of the set of offers common to the selected combination of entities.

Preferably, in the electronic system according to the invention, the generation of the graphical representation of an ad is performed with the use of the template of an advertising banner of B2C entity belonging to the combination of entities which are related to the joint advertising display.

Preferably, in the electronic system according to the invention, step d) consists, in particular, of sending, in electronic form, the graphical representation of an ad, which is to be displayed to the end user.

Preferably, in the electronic system according to the invention, step d) consists, in particular, of sending, in electronic form, the pricing performed on the basis of payment models of particular entities which are related to the joint advertisement.

Preferably, in the electronic system according to the invention, step d) consists, in particular, of sending, in electronic form, the list of entities which are related to the joint advertisement, together with information about payment models of each entity.

The invention has been illustrated in embodiments and in a drawing in which

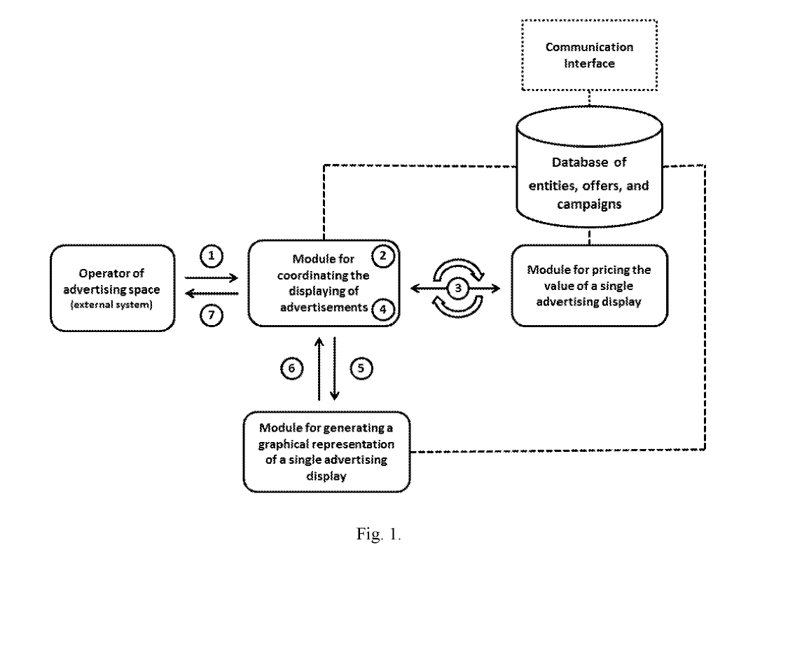

FIG. 1 shows a step-by-step example of the operations of the invention, from the moment of reception, from the Operator of the advertising space, of information about the possibility to display a single display, until the moment of providing feedback with the proposed graphical representation of an ad and with its pricing,

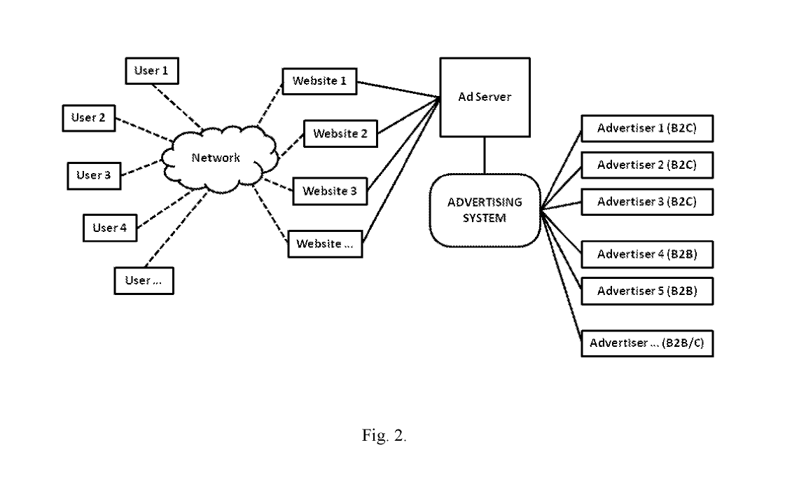

FIG. 2 shows schematically a mode of operation of the invention in a broader business context in the case where digital advertising would be displayed on the Internet,

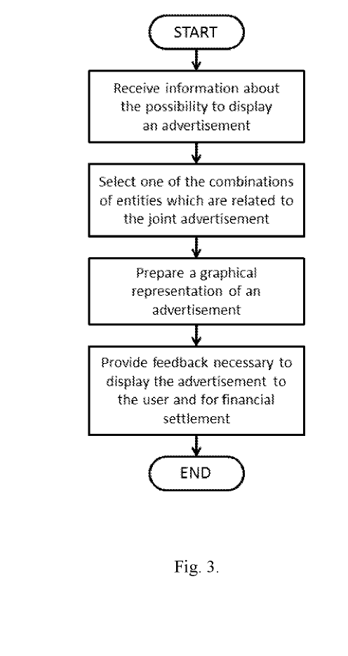

FIG. 3 shows the most general scheme of operation of the invention, and

FIG. 4 shows an example design of a horizontal advertising banner, and

FIG. 5 shows an example design of a vertical advertising banner, showing the data in a columnar manner.

### DESCRIPTION OF THE OPERATIONS OF THE INVENTION

The most general scheme of the operations of the invention is presented in FIG. 3. An embodiment of the invention in the form of an electronic system that performs the basic functionality is described below. The system consists of several modules that communicate with each other.

### List of Modules:

1. Database of entities, offers, and campaigns. The database stores the information concerning (below, basic information was listed, which in the practical implementation of the module can be expanded with additional data):
a. entities (with the division into B2C and B2B)
   i. name
   ii. potentially, a logo
   iii. for B2C entities, a template of advertising banners
b. offers of B2C entities
   i. name
   ii. offer features such as, for example, price, image, url link, category—these elements can be subsequently displayed as part of the graphical representation of an ad
   iii. indication of which B2C entity offers a given offer to the end customer
   iv. indication of which B2B entities are in the supply chain of a particular offer
c. list of advertising campaigns conducted by particular entities (a single entity can have several campaigns, which differ for example, in regards to targeting)
   i. indication of entity to which a given campaign belongs (a single entity)
   ii. indication of a campaign (name)
   iii. payment model
   iv. campaign budget
   v. elements related to targeting (if a campaign concerns a specific category of offers, landing pages, or other parameters related to the narrowing of the context of displays)

2. Communication interface. The communication interface allows to manage data stored in the database. The interface can allow for both manually and automatically entering or updating the data.

3. Module for coordinating the displaying of advertisements. This module, after the reception of information about the need to display the advertisement in a specific advertising space (in a specific context), browses through all the campaigns of B2C entities. For each B2C campaign, it also browses the campaigns of B2B entities which declared their willingness to co-finance advertisements of a selected B2C entity. For each combination of entities (their advertising campaigns), the module sends information to the Module for pricing the value of a single advertising display in order to achieve the highest possible pricing. After determining the best set of entities financing a particular display, the Module sends relevant information to the Module for generating a graphical representation of an ad and, having obtained the result, sends it together with the pricing back to the operator of the advertising space. The Module for coordinating the displaying of advertisements may send back also additional information necessary for displaying the advertisement to the user and for financial settlement, such as a list of entities which are related to the advertisement, or payment models declared by them.

4. Module for pricing the value of a single advertising display. On the basis of the campaign list of entities which are related to a given display, in particular, taking into account the declared payment models and context of the display, the module prices the total value of the joint advertising display, which may be subsequently passed to the Operator of the advertising space (it may be a pricing used subsequently, for example, in the bidding of advertising space or in the selection of the most valuable advertisement, in case a bidding model is not adopted). Value of the display is calculated as a sum of values of the advertising display from the point of view of each of the financing entities.

5. Module for generating a graphical representation of a single advertising display. The Module receives, at its input, information to which B2C entity and to which B2B entities the advertisement will be related. Also, information about the context of the display (in particular, about the format of the advertisement) is transmitted. Selected data necessary for generating final graphical representation of an ad is automatically placed onto the appropriate template of an advertising banner of a B2C entity. Sample data necessary to obtain the final view include logo of entities, or data about offers from the set of offers common to a combination of entities co-financing a given advertisement. Sample templates of advertising banners are presented in FIG. 4 and FIG. 5. In the case of the first banner, to generate the final graphical representation of an ad, there is a need to insert two logos of entities and data concerning four offers from the set of common offers into the empty spaces on the template. The other banner may be used when the advertisement is financed by three entities. To generate the final view, there is a need to insert to the template three logos and data concerning four offers from the set of offers common to a given combination of entities. The Module does not have to generate a new graphical representation of an advertising banner every time, it may, for example, store in the database the views generated before, and at the time of a new advertising emission only provide a ready result (if this result meets all the requirements from the point of view of the current advertising display).

The scheme of an embodiment of the invention is illustrated in FIG. 1 which shows a step-by-step example of operations of the invention, from the moment of receiving the info about the possibility to display a single ad from the Operator of the advertising space, until the moment of providing feedback with the proposed graphical representation of an ad and with pricing of this display. In principle, in the vast majority of these cases, before the beginning of the advertisement emission process, the database is already complemented with certain information about the entities, their offers, and campaigns—this information is placed and updated in the database on a regular basis, independently of the advertisement emission process, using the Communication Interface made available to particular groups of interested entities.

Detailed description of particular steps shown in FIG. 1:

Operator of advertising space sends the information about the possibility to display the advertisement to the Module for coordinating the displaying of advertisements.
Information which is transmitted to the Module:
   context data of the advertising display (for example: url address at which the advertisement is to be displayed, advertisement format (e.g. 750×200 pixels), potentially a user profile, etc.)
The following is to be eventually returned by the Module:
   graphical representation of an ad together with the pricing of the given display (in point 7.)

2. The Module for coordinating the displaying of advertisements actively browses through the campaigns of all B2C entities in terms of their compliance with the context of the display (only the campaigns meeting the targeting criterion are considered).

3. For each of the considered campaigns of particular B2C entities, all the campaigns of B2B entities which meet the targeting criterion, and also could potentially co-finance the campaign of B2C entity are browsed through (in particular, those which occur together in a supply chain of at least part of the offers of B2C entity, and thereby for which the set of offers common to the considered combination of entities comprises at least one element). For each combination of campaigns of B2C and B2B entities which meet the aforementioned conditions, a query is sent to the Module for pricing the value of a single advertising display in order to obtain a comprehensive value of a given advertising display based on the declared payment models of campaigns of particular entities (each of the entities can have a different declared payment model, various payment models can affect in different ways the total value of display—the simplest model may be the model under which the entity is charged with a fixed rate for each advertising display; if all entities use this model, then the total value of the display will be the sum of the rates declared by each of the entities).
Information which is transmitted to the Module for pricing the value of a single display (As part of point 3, this query is called multiple times for various combinations of campaigns of entities which may potentially finance the given display):
   context data of the advertisement
   campaign identifier of B2C entity
   list of campaign identifiers of B2B entities
Information returned to the Module for coordinating the displaying of advertisements:
   total value of display calculated on the basis of payment models of particular campaigns of entities which are to finance the given display

4. On the basis of the collected pricings, the best (the most valuable) combination of campaigns of entities which may co-finance the given advertising display is chosen.

5. The Module for coordinating the displaying of advertisements sends an appropriate query in order to obtain the final graphical representation of an ad banner to the Module for generating a graphical representation of an ad. The view is generated on the basis of the template of an advertising banner of the B2C entity to which the joint advertisement relates. Selected data necessary to generate the final view of the advertisement is than inserted onto the mentioned template. In particular, if information concerning offers is to appear in the advertisement, these will be the offers selected from the set of offers common to the combination of entities which are related to the joint advertisement. Selection of offers can also be narrowed, depending on the context data of the display (for example narrowing the offers to thematic categories). The design may also be complemented with logos of entities which are related to the joint advertisement (that is, for example, on a store's banner, the store and the manufacturer's logos and given manufacturer's offers for the store appear, as part of the display co-financed by one of the manufacturers of goods offered by a given store). Graphical representation of an ad may be generated at the current moment, or if the view currently needed was generated before and saved in the database (e.g. on the occasion of another advertising display), then the module can immediately provide the ready result.
Information which is transmitted to the Module for generating a graphical representation of an ad:
   context data of the advertising display (in particular, advertisement format)
   identifier of B2C entity, whose advertising banner is to be displayed as part of the given display
   list of identifiers of B2B entities (may be empty) co-financing the given display

6. Graphical representation of an ad is returned to the Module for coordinating the displaying of advertisements.

7. The Module for coordinating the displaying of advertisements returns the prepared graphical representation of an ad together with the pricing of the given display, potentially with additional information necessary to display the advertisement to the user and for financial settlement to the operator of advertising space.

It should be noted that after a possible display of the advertisement in a real system, several other events will occur, for example potential updating of campaign budgets of particular entities financing the advertisement, updating of statistics, etc. However, these elements are not associated with the invention, thus they are not described in this document.

The shown modular scheme is illustrative, and may be, in a specific case, implemented in a different way. The particular modules could be consolidated, which allows them to perform a greater number of functions, or they can be separated into smaller ones. Therefore, also communication between the modules could be different than in the presented scheme.

The object of the invention is gathering the information about both B2C and B2B entities. In particular, storing information about offers of B2C entities together with their connections with other entities within supply chains, into one IT system. But also gathering information about willingness to potentially co-finance, by particular entities in the supply chain, joint advertisements promoting offers among end consumers (together with expressly declared budget, payment model for each of the entities, and templates of advertising banners) within that system. Thanks to this solution, it is possible to automate the process of entity selection, pricing and preparation of joint digital advertisements co-financed by several entities in a supply chain of products or services.

Until now, not all of the elements required to launch a joint marketing campaign were gathered within one system. Therefore, the automation was difficult, if not impossible. Particular entities in a supply chain, wanting to engage in a joint advertising campaign, had to physically arrange financial terms, prepare advertising creatives and purchase appropriate media.

In FIG. 2, an example of implementing the system in a broader business context, in case where digital advertisements would have to be displayed on the Internet, is presented. Network users are visitors to websites. On selected websites, advertising space is available, the space being managed by the operator of advertising space who technologically uses an advertising server for this purpose. The advertising server is connected to an advertisement system which is designed to emit joint advertisements co-financed by several entities. The system is used by various entities which want to advertise their offers. They are both B2C and B2B entities.

These entities, via appropriate interfaces, transmit relevant information concerning their offers, advertising campaign settings, in particular, preferable payment models for advertising services to the advertising system. Each time a user goes to the website on which the advertising space managed by the system was placed, information about the possibility of potential display goes to the advertising system. On the basis of the context of the advertising display, a certain combination of entities, which are related to the given displaying of a joint advertisement, is selected. Having selected a final combination of entities, a graphical representation of an ad, which is to be displayed to the user, is generated. On the basis of the payment models declared by the selected entities, pricing of the display is simultaneously calculated. Information about the pricing together with the graphical representation of an ad returns to the advertising server, which directly displays the graphical representation of the ad to the user. On the basis of the pricing of the display, a corresponding amount is settled by the operator of the advertising space to deliver to the owner of the site on which the advertisement was displayed. On the other hand, budgets of the entities co-financing the display are also updated based on the payment models declared by them.

The invention can be used in many marketing products in the digital industry. These products can be used in digital media, especially on the Internet, in mobile communication, in any digital displays and in television, including Internet television. Examples of implementation of the invention in various marketing products aimed at various target groups:
Online stores and manufacturers of goods on display advertising:
   The product which uses the invention may consist of displaying personalized remarketing, contextual or behavioral targeting display advertising (image advertisements displayed on websites) of online stores (B2C entities) co-financed by manufacturers of goods offered by these stores (B2B entities),
Online stores and manufacturers in search engines:
   Product analogous to the ones above, wherein the advertisements of online stores would be displayed in search engines,
Services gathering tourist offers and tour operators/hotels/airlines:
   B2C entities in this case would be entities which aggregate tourist offers (for example Internet tourist services). B2B entities would be travel agencies, airlines, and hotels, whose offers are sold via the said B2C entities,
Mobile communications operators and mobile phone/tablet/laptop manufacturers:
   B2C entities are mobile communications operators, which offer packages including mobile phones, tablets or laptops. B2B entities are manufacturers of equipment offered by the said B2C entities.
Car manufacturers and dealers:
   B2C entities are car dealers. B2B entities are car manufacturers.
Entities from the film industry:
   B2C entities may be services which offer ticket sales or movie theaters. B2B entities may be film producers, local distributors, and also cinemas (in the case where movie tickets are sold by consecutive agents, like the mentioned services which sell various tickets).

1-30. (canceled)

31. A method of emitting a joint digital advertisement, comprising the following steps:
a) receiving information requesting display of the joint digital advertisement for a product or service;
b) automatically selecting one of a plurality of combinations of entities to be promoted on the joint digital advertisement, wherein the entities are related to the joint digital advertisement in that each entity participates in a supply chain for the product or service being advertised;
c) preparing a graphical representation of the joint digital advertisement for display, using a template of an advertising banner, which is filled with data including information about at least one offer from a set of offers common to the one of the plurality of combinations of entities; and
d) providing feedback to display the joint digital advertisement to a user.

32. The method according to claim 31, wherein the data filling the advertising banner further includes one or more logos of entities of the one of the plurality of combinations of entities related to the joint digital advertisement.

33. The method according to claim 31, wherein receiving information requesting display of the joint digital advertisement comprises electronic transmission of context data of the advertising display.

34. The method according to claim 31, wherein automatically selecting one of the plurality of combinations of entities, which are related to the joint digital advertisement, includes meeting targeting criteria of an advertising campaign of the one of the plurality of combinations of entities.

35. The method according to claim 31, wherein automatically selecting one of the plurality of combinations of entities is made from a set of all potential combinations of entities included in the plurality of combinations of entities.

36. The method according to claim 31, wherein step b) includes selecting, from considered combinations of the plurality of combinations of entities, the one of the combinations of entities for which a calculated pricing of display of the joint digital advertisement is highest among the considered combinations.

37. The method according to claim 36, wherein selecting, from the considered combinations, the one of the combinations of entities for which the calculated pricing of display is highest, is made according to pricing based on payment models declared by the entities, which are related to display of the joint digital advertisement.

38. The method according to claim 31, wherein step b) includes selecting a combination of entities which includes exactly one business-to-consumer (B2C) entity and at least one business-to-business (B2B) entity.

39. The method according to claim 31, wherein preparing the graphical representation of the joint digital advertisement includes of automatic generation of the graphical representation of the joint digital advertisement responsive to receiving the information requesting display of the joint digital advertisement.

40. The method according to claim 31, wherein the preparation of the graphical representation of the joint digital advertisement for display includes indicating an already-existing graphical representation of the joint digital advertisement, generated before receiving the information requesting display of the joint digital advertisement.

41. The method according to claim 31, wherein the template of the advertising banner is a template associated with a business-to-consumer (B2C) entity included within the one of the plurality of combinations of entities.

42. The method according to claim 31, wherein a subset of a set of offers common to the plurality of combinations of entities which are related to the joint digital advertisement is narrowed according to context data of the advertising display.

43. The method according to claim 31, wherein step d) includes providing the graphical representation of the joint digital advertisement to be displayed to the user.

44. The method according to claim 31, wherein step d) includes providing calculated pricing of display of the joint digital advertisement performed on the basis of payment models declared by the entities, which are related to the joint advertisement.

45. The method according to claim 31, wherein step d) includes providing a list of the entities of the one of the plurality of combinations of entities which are related to the joint digital advertisement, together with information about payment models of each of the entities of the list.

46. An electronic system for emitting a joint digital advertisement, comprising a database, a communication interface, and a database-integrated mechanism, the system configured to perform operations including to:
a) receive information requesting display of the joint digital advertisement for a product or service;
b) automatically select one of a plurality of combinations of entities to be promoted on the joint digital advertisement, wherein the entities are related to the joint digital advertisement in that each entity participates in a supply chain for the product or service;
c) prepare a graphical representation of the joint digital advertisement for display, using a template of an advertising banner, which is filled with data including information about at least one offer provided by the one of the plurality of combinations of entities; and
d) provide feedback to display the joint digital advertisement to a user.

47. The electronic system according to claim 46, wherein the data filling the advertising banner further includes one or more logos of entities of the one of the plurality of combinations of entities related to the joint digital advertisement.

48. The electronic system according to claim 46, wherein operation a) includes receipt of electronic transmission of data including context data of the advertising display.

49. The electronic system according to claim 46, wherein operation b) is performed with the use of a module communicating with the database, the module, based on the information contained in the database, configured to select, from a set of all potential combinations of entities, a combination of entities for which targeting criteria are met.

50. The electronic system according to claim 46, wherein operation b) includes selection of the one of the plurality of combinations of entities according to a criterion of a highest pricing for display of the joint digital advertisement among the plurality of combinations of entities.

51. The electronic system according to claim 50, wherein pricing the display of the joint digital advertisement for a given combination of entities is performed with the use of a module communicating with the database.

52. The electronic system according to claim 51, wherein the operation pricing the display of the joint digital advertisement for a given combination of entities, with the use of the module communicating with the database, is performed based on information contained in this database descriptive of payment models declared by the entities of the one of the plurality of combinations of entities.

53. The electronic system according to claim 46, wherein operation b) is performed with use of information from the database such that the one of the plurality of combinations of entities includes exactly one business-to-consumer (B2C) entity and at least one business-to-business (B2B) entity.

54. The electronic system according to claim 46, wherein the operation for preparing the graphical representation of the joint digital advertisement includes automatic generation of the graphical representation of the digital joint advertisement responsive to the information requesting display of the digital joint advertisement.

55. The electronic system according to claim 46, wherein the operation for preparing the graphical representation of the joint digital advertisement is includes indication, in the database, of a prepared graphical representation of the joint digital advertisement, generated before receiving the information requesting display of the joint digital advertisement.

56. The electronic system according to claim 46, wherein generation of the graphical representation of the joint digital advertisement is performed by a module communicating with the database, the module being configured to automatically fill the template of the advertising banner with graphical elements.

57. The electronic system according to claim 46, wherein the template of the advertising banner is a template associated with a business-to-consumer (B2C) entity included within the one of the plurality of combinations of entities which are related to the joint digital advertisement.

58. The electronic system according to claim 46, wherein operation d) includes sending, in electronic form, the graphical representation of the joint digital advertisement, which is to be displayed to the user.

59. The electronic system according to claim 46, wherein operation d) includes providing calculated pricing of display of the joint digital advertisement performed on the basis of payment models declared by the entities, which are related to the joint advertisement.

60. The electronic system according to claim 46, wherein operation d) includes sending, in electronic form, a list of the entities of the one of the plurality of combinations of entities which are related to the joint digital advertisement, together with information about payment models of each of the entities of the list.
